(19) United States
(12) Patent Application Publication
(10) Pub. No.: US 2021/0190574 A1
(43) Pub. Date: Jun. 24, 2021

(54) FLUID LEVEL SENSORS

(71) Applicant: HEWLETT-PACKARD DEVELOPMENT COMPANY, L.P., Spring, TX (US)

(72) Inventors: Kevin Rourke, Leixlip Co. Kildare (IE); Ivor Cummins, Leixlip, Co. Kildare (IE); Jody L. Clayburn, Vancouver, WA (US)

(21) Appl. No.: 16/605,018

(22) PCT Filed: Oct. 18, 2017
(86) PCT No.: PCT/US2017/057155

§ 371 Date: Oct. 14, 2019

(51) Int. Cl. G01F 23/296; B41J 2/175

(52) U.S. Cl. CPC G01F 23/2967; B41J 2002/17573; B41J 2/17566; B41J 2/17546

(57) ABSTRACT

In an example, a fluid level sensor comprises a vibrational paddle wherein an edge of the vibrational paddle comprises a fluid surface contact point having a peaked profile.

### BACKGROUND

The vibrational behavior of vibrating elements may be used in some examples to detect the presence and/or level of a liquid. For example, a vibrational element such as a ‘tuning fork’ may vibrate at a resonant, or ‘natural’ frequency in air, but in liquid such vibration may be damped.

### BRIEF DESCRIPTION OF THE DRAWINGS

Non-limiting examples will now be described with reference to the accompanying drawings, in which:

FIGS. 1 to 3 and FIGS. 4A-4C are examples of fluid level sensors;

FIG. 5 is an example of a replaceable print apparatus component comprising a fluid level sensor;

FIG. 6A is an example of a print agent container comprising a fluid level sensor; and

FIG. 6B is an equivalent circuit to the apparatus shown in FIG. 6A.

### DETAILED DESCRIPTION

In some examples, a fluid level may be detected using a vibrating element. For example, such a vibrating element may be positioned within a fluid reservoir. In some examples herein, the fluid reservoir is a print agent container for use in printing. For example, in inkjet printing, a print cartridge may contain a supply of ink which is used to form text and images on a substrate. The level of ink in the print cartridge may be used to indicate to the user when the ink is about to run out, or to estimate the rate at which ink is being dispensed.

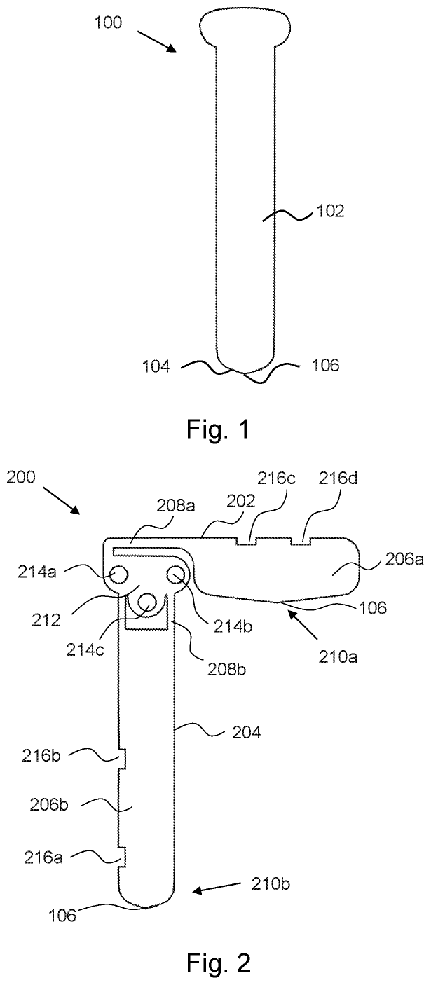

FIG. 1 is an example of a fluid level sensor 100 comprising a vibrational paddle 102 wherein an edge 104 of the vibrational paddle 102 comprises a fluid surface contact point 106 having a peaked profile. As shown in the example, this may comprise a narrowing to a point.

In use, the fluid level sensor 100 may be arranged in a fluid container such that the fluid surface contact point 106 is oriented lowermost. In this way, as a liquid level falls, the fluid surface contact point 106 will be uncovered last. By providing a fluid surface contact point 106 which has a peaked profile, the influence of tilt on the level at which the vibrating paddle is uncovered will be minimized. The point also provides a more distinct state change than a flattened edge and can help to dissipate any foam on the surface of the liquid.

In some examples, the paddle 102 may be substantially rectangular, and the peak may be formed in a long or short edge of such a rectangular paddle 102.

In some examples, the fluid level sensor 100 may be for use in a print agent reservoir, for example a print cartridge. The dimensions of the fluid level sensor may be selected accordingly.

In some examples, the fluid level sensor 100 may have a resonant or ‘natural’ vibrational frequency on the order of 10 to 100 Hz. This is within the range of frequencies that may be readily fabricated using stainless steel flat springs (which may be a suitable material choice for the fluid level sensor 100) with dimensions suitable for inclusion in print apparatus components, and detection apparatus which may be used in detecting the movement of the sensor 100 (for example, analogue to digital converters) which are sensitive to this range are readily available. In addition, it may be noted that fluid level sensors 100 with higher resonant frequencies have lower displacement for the same quantity of input energy and therefore the movement of a fluid level sensor 100 becomes more difficult to detect with increasing resonant frequency. Moreover, when seeking to accurately characterize an oscillation, higher frequencies are associated with higher sampling rates. Higher sampling rates in turn consume greater monitoring and processing resource.

The lower end of the frequency range may be associated with the size of the fluid level sensor 100 (which may in turn be limited by the size of a container, which as noted above may in some examples be a print apparatus component such as a print agent cartridge). Thus, with different processing, material and/or size constraints, different frequency ranges may be appropriate.

In some examples, frequencies around national power supply frequencies (for example, around 50 Hz and 60 Hz in most countries) may be avoided, as this can result in a false reading due to the power supply signal.

In some examples, the fluid level sensor 100 may comprise a stamped spring like component, and/or may be substantially planar. For example, the fluid level sensor 100 may comprise a stamped spring plate. Providing such a planar sensor 100 may be of use in certain fluid containers (such as print cartridges) which are constrained in one direction. In other examples, the fluid level sensor 100 may comprise a coiled spring or the like. In some examples, the sensor 100 may be fabricated from a material which is selected for vibrational characteristics and/or corrosion resistance. In some examples this may comprise a metal, for example stainless steel, or a plastic, or the like.

Where such a fluid level sensor 100 is provided in a print apparatus component, it may be fixed to the component at a mounting point (e.g. the widened end of the sensor 100 shown in the Figure, although such a widened end may not be shown in all embodiments), whereas a distal portion of the vibrational paddle 102 may be free to move. The nature of the movement of the vibrational paddle 102 may be used to determine a fluid level. In particular, when subjected to a stimulus, the movement of the paddle 102 may indicate if the paddle is in fluid or in air.

A stimulus applied may take various forms. For example, an impulse, or sudden force, may be applied by causing a moving component containing the fluid level sensor 100 to rapidly decelerate, for example by stopping a carriage housing the component (which may be a print apparatus component) suddenly, or by causing the carriage to knock against a stopping member. In other examples, an external device, such as an electromagnet, may be used to generate an impulse force, for example by generating a magnetic field to act on the vibrational paddle 102 of the fluid level sensor 100 then removing the magnetic field, to cause the vibrational paddle 102 to oscillate as it returns to a resting position.

Another way of causing movement of the vibrational paddle 102 is to cause movement of the fluid level sensor 100 at a defined driving frequency. In some examples, a direction of movement of a print apparatus container containing a sensor 100 may be rapidly and repeatedly be reversed. Such movement may be referred to as cyclic movement. For example, a mechanism for causing a carriage to move within a printing apparatus may cause a fluid container such as a print agent cartridge to move backwards and forwards, for example along a track, at a defined frequency. Fluid, such as print agent within a fluid container, may be caused to slosh from one side of the fluid container to an opposite side of the fluid container at the same defined frequency. The moving liquid may cause the paddle 102 of the fluid level sensor 100 to oscillate at the same frequency.

The position of the vibrational paddle 102 may in some examples be detectable capacitively. For example, the vibrational paddle 102 may function as (if the fluid level sensor 100 is conductive), or may comprise, a capacitive plate, and another capacitive plate may be mounted on a surface of the print apparatus component and the capacitance may be monitored via a circuit (which may for example be provided as part of the print apparatus). For example, an impulse may be applied and the capacitance of the circuit comprising a sensor 100 may change at a rate corresponding to a characteristic wavelength of fluid with the container if the fluid level sensor 100 is submerged in fluid, or at the resonant or natural frequency of the fluid level sensor 100 if the vibrational paddle 102 is in air.

FIG. 2 shows an example of a two limb fluid level sensor 200, in which the limbs are mounted at relatively offset angles. In this example, a first substantially horizontal arm 202 and a second substantially vertical arm 204 is provided. While in this example, the arms are substantially orthogonal to one another, this may not be the case in all examples. However, it may be noted that the illustrated design results in efficient nesting in raw material, for example if the sensor 200 is formed using a stamping process. Each of the arms 202, 204 comprises a distal portion 206a, 206b, and a proximal portion 208a, 208b. In each case, the proximal portion 208a, 208b has a first solid surface area per unit length and the distal portion 206a, 206b has a second solid surface area per unit length, wherein the second solid surface area is greater than the first solid surface area. In other words, the distal portions present a greater surface area against which fluid may act per unit length, and therefore provide vibrational paddles 210a, 210b. In this example, the paddles 210 are formed with fluid contact points 106 having peaked profiles as described above in relation to FIG. 1, but this need not be the case in all examples.

In the illustrated example, the horizontal arm 202 achieves the reduction in surface area by having a narrow section forming the proximal portion 208a (i.e., the proximal portion has a first width and the distal portion has a second width, the second width being greater than the first width), whereas the vertical arm 204 achieves this reduction in surface area by having a cut-out section formed in the proximal portion 208b. In other examples, a region of relatively high flexibility may be provided by selecting a more flexible material for a region, or there may be no region of increased flexibility. It may be noted that a region of increased flexibility may be provided in conjunction with, or separate from, other features of a fluid level sensor 100, 200.

It may be noted that the length of such a proximal portion 208, or the amount of material cut-out therefrom, will have an effect on the vibrational behaviour of that arm 202, 204. Providing portions of increased flexibility (for example by providing a region of reduced surface area) may increase the displacement caused by a particular stimulus and/or increase the decay period, and therefore increase signal strength. By providing a cut-out rather than a narrowed portion, there may be increased handling robustness in manufacture as the proximal portion 208 is supported on both sides. In addition, this may assist in reducing torsional and/or longitudinal cross talk.

It may be noted that, by providing a plurality of vibrational paddles 210a, 210b, the fluid level may be sensed at various heights. For example, it may be determined when the paddle 210a on the horizontal arm 202 becomes uncovered a fluid level in a container containing the sensor 200 reduces and, subsequently, it may be determined when the lower paddle 210b on the vertical arm 204 is uncovered. In some examples, detection may be carried out using a capacitive sensor, wherein the paddles 210 provide first plates of a capacitive sensor and a second plate is mounted, for example on the interior or exterior of a housing of a fluid container. The movement of the paddles 210 may be sensed for example capacitively (with the paddles each acting as a plate of a capacitor), inductively or in some other way.

Again, in this example, the fluid level sensor 200 may comprise a stamped spring plate. By stamping the fluid level sensor 200, it may be formed without requiring joints, hinges or the like.

In this example, the fluid sensor 200 comprises a mounting point 212, which in this example comprises a plurality of fixing points 214a, 214b, 214c. By providing a plurality of fixing points 214, the position of the sensor 200 within a container may be readily constrained. It may be noted that, in this example, the fixing points 214 are relatively spaced to provide a solid region therebetween. This solid region may allow the fitting of additional components. In some examples, this may allow a suitably sized vacuum cup for a “pick and place” operation to engage with the mounting point 212, for example during manufacture.

In this example, it may be noted that the horizontal arm 202 overreaches the vertical arm 204 and the mounting point 212. This in effect allows the horizontal arm to be longer without increasing the overall footprint of the sensor 200. The width of the continuous material forming the link between the arms 202, 204 may be selected so as to provide an intended frequency. It may be noted that the width may be altered without changing the outer envelope of the sensor 200.

In this example, it may be noted that vibrational paddles 210a, 210b formed in the distal portions of the fluid level sensor 200 comprise rounded corners. This may assist in reducing damage to any other components which the fluid level sensor 200 may come into contact with.

In this example, the arms 202, 204 each comprise a plurality of attachment points 216a-d for mounting a removable mass. For example, the mass may comprise a clamshell mass. Adding a mass to a particular attachment point 216a-d may change the resonant behaviour of the sensor 200. By providing attachment points 216a-d in such positions, the repeatable placement of an added mass is facilitated. In this example, attachment points 216a-d comprise notches formed on the edges of the arms 202, 204. However, in other examples, these may comprise any feature which allows a mass to be attached at a particular location, for example comprising a cut-out, protrusion or the like.

In one example, the thickness of each arm 202, 204 may be around 0.5 to 2 mm. The length of each arm 202, 204 may be on the order of 2 to 5 mm, or up to around a few centimetres. These values may be selected with a view to the robustness and natural or resonant frequency of the sensor 200. It may be noted that stiffness is a function of the thickness of each arm 202, 204 to the third power but a function of the width of the each arm 202, 204 to the first power, meaning that varying the width may ‘fine tune’ vibrational performance.

An example of a sensor 200 comprising two such masses 300a, 300b is shown in FIG. 3.

In this example, it may be the case that the arms 202, 204 can exhibit substantially the same resonant frequency, or different resonant frequencies, depending on the placement of the mass 300. For example, if the mass 300 is mounted at the inner position, the resonant frequency of both arms may be around 30 to 40 Hz, whereas if the mass 300 is mounted at the outer position on each arm (as is shown in Figures), that arm may exhibit vibrational resonance at between 20 and 30 Hz. In some examples, the masses 300 may for example be around 0.2 to 0.5 g.

For example, this may allow selection of a first arm to vibrate at a first frequency and the second arm to vibrate at a second frequency, but these frequencies may be switched to the alternative arm between different instances of the sensors 200.

In examples in which the arms 202, 204 have different natural or resonant frequencies (be that by placement of the mass 300 or due to the form and/or materials thereof), the response of the arms 202, 204 may be distinguishable even when the arms 202, 204 are connected in series to a single sensing circuit, as the response will have characteristics of both frequencies. In other examples, the arms 202, 204 may have the same response, and the strength of the response signal could be utilized to determine if just one or both arms 202, 204 was responding at its resonant frequency. In other examples, each arm 202, 204 may be monitored individually.

While examples utilizing one and two vibrating elements have been described above, in principle any number of vibrating elements could be provided.

FIGS. 4A-C provide examples of alternative designs for a fluid level sensor, and parts in common with the sensor 200 of FIGS. 2 and 3 are labelled with like numbers.

FIG. 4A shows another example of a fluid level sensor 400, in this case comprising two orthogonal arms 402, 404. It may be noted that, in this example, the narrow proximal portion of the arms are relatively long, which may alter the vibrational characteristics, as well as the strength of the component. This is one example of how a design may be tailored to a particular use case.

FIG. 4B shows an example of a ‘Z-shaped’ sensor 406, comprising a vibrating arm 408 and a fixed plate 410, which in use of the sensor 406 within a print apparatus component may be fixed at a predetermined distance from a second capacitive plate, to which it may be capacitively coupled. The second capacitive plate may be electrically coupled to a sensing apparatus (which may for example be provided as part of the print apparatus), which may sense the changes in capacitance associated with a change in the dielectric there between from liquid when submerged in a print agent to air when the print agent level falls below the level of the fixed plate 410. The tapered shape of the fixed plate 410 may assist in discerning dropping fluid levels. The motion of the end of the vibrating arm 408 may be sensed as described above, for example capacitively.

FIG. 4C shows an example of a sensor 412 comprising relatively short arms. Shorter arms provide increased overall robustness and reduce chance of entanglement of sensor 412 during manufacture (for example within vibratory feeder or similar), as another sensor 412 can no longer fit into this hole. By providing shorter arms, the vibrational frequency may increase, reducing a minimum sampling rate to correctly characterize the movement of the sensor. Masses may optionally be fitted at the attachment points 216a, 216b.

It may be appreciated that the illustrated examples provides just some examples of the design options available, and many variations on these designs or combinations of features of different designs could be made.

In particular, sensors may have any number of oscillating members, which may be orientated in any direction. Sensors may comprise any or any combinations of: a region of increased flexibility, a peaked fluid contact point, an arm which ‘over reaches’ a contact point, rounded corners, any number of mass attachment points, and the like. Any of these features may be provided in the absence of any other feature.

In some examples, sensors may be bent such that any mounting point and the vibrating paddle are not aligned, for example such that when a mounting point is fixed to a wall of a print apparatus component, a vibrational paddle may be spaced therefrom and free to move. In other examples, the mounting point may provide a ‘platform’ which provides a spacing between a paddle and a wall.

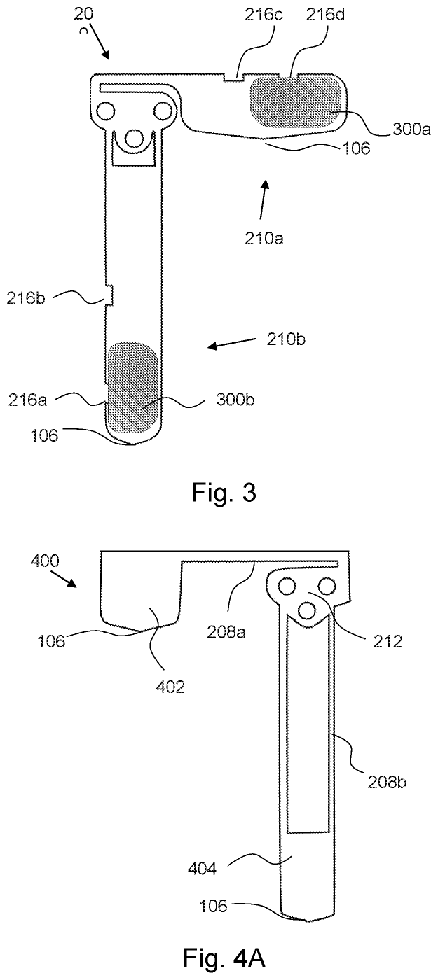

FIG. 5 is an example of a replaceable print apparatus component 500 comprising a fluid container 502 and a fluid level sensor 504 disposed within the fluid container 502 comprising first and second vibrational arms 506, 508, wherein the first and second arms 506, 508 extend in different directions, are disposed at different fluid depths within the container and are associated with respective first and second resonant or vibrational behaviors. In some examples, the first and second resonant behavior may be the same—in other words, the first and second resonant behavior may comprise substantially the same resonant frequency, signal strength (displacement in response to a stimulus) and/or decay rate of vibration. In other examples, the first and second resonant/vibrational behavior may be the same—in other words, the first and second resonant/vibrational behavior may comprise substantially different frequency, signal strength and/or decay rate of resonance.

In some examples, as a shown in the Figure, the first and second arm 506, 508 extend from a common origin. However, this may not be the case in all examples. In addition, as a shown in the Figure, the first arm comprises a longitudinally extending arm and the second arm comprises a laterally extending arm, but this need not be the case in all examples.

In some examples, as has been shown above, the second arm may extend across the width of the first arm, or vice versa. This may assist in minimising material use whilst providing a relatively long lateral extension for a given footprint of the fluid level sensor 504.

In some examples, the fluid level sensor 504 may comprise a ferromagnetic material, such that it can be excited by magnet (which may be an electromagnet, controlled to carry out a sensing operation). In some examples, at least a part thereof may be electrically conductive and/or capable of acting as a plate in a capacitor (for example, an end region of the arms 506, 508).

The fluid level sensor 504 may have any of the characteristics described above. For example, it may be relatively flat or planar, although in other examples the fluid level sensor 504 may comprise a spring or a coil. The fluid level sensor 504 may be a monolithic component i.e., formed of a single piece of material. In other examples the sensor 504 may be jointed although this results in additional manufacturing processes. The fluid level sensor 504 may comprise a flexible portion (e.g. a narrowed portion, or a cut-out portion), as is described above, to increase the displacement following stimulus thereof.

The sensor 504 may comprise rounded corners and/or may comprise a conductive material, as has also been described above.

In some examples, at least one of the first and second vibrational arms 506, 508 comprises a vibrational paddle wherein an edge of the vibrational paddle comprises a fluid surface contact point having a peaked profile, as has been described above.

In use, any of the fluid level sensors 100, 200, 400, 406, 412, described herein may be placed within a print apparatus component 500, for example a print agent container or a print agent cartridge. In order to determine a fluid level, a portion (for example the vibrational paddles 102, 210) of the sensor 100, 200, 400 406, 412 may act as a plate of a capacitor. A second plate of the capacitor may be provided on a housing of the print apparatus component 500. In some examples, the fluid level sensor 100, 200, 400, 406, 412 may be provided inside the housing of a print apparatus component and the second plate of the capacitor may be provided outside the housing. In use, the first and second plate may be capacitively coupled. Vibration of the fluid level sensor 100, 200, 400, 406, 412 can be sensed as a changing capacitance of the circuit including the first and second capacitive plates. Therefore, for example, resonant behaviour (i.e. vibration at the resonant or natural frequency of the sensor or an arm thereof) may be detected as a variation in capacitance having a frequency which is at the resonant or natural frequency of a sensor 100, 200, 400, 406, 412. Such resonant behaviour will be seen when the corresponding vibrational paddle 102, 210 is fully uncovered by liquid. Thus, it may be detected when the fluid in the container is below the paddle 102, 210. Where a plurality of paddles 102, 210 are provided, the fluid level may be determined at various fluid depths.

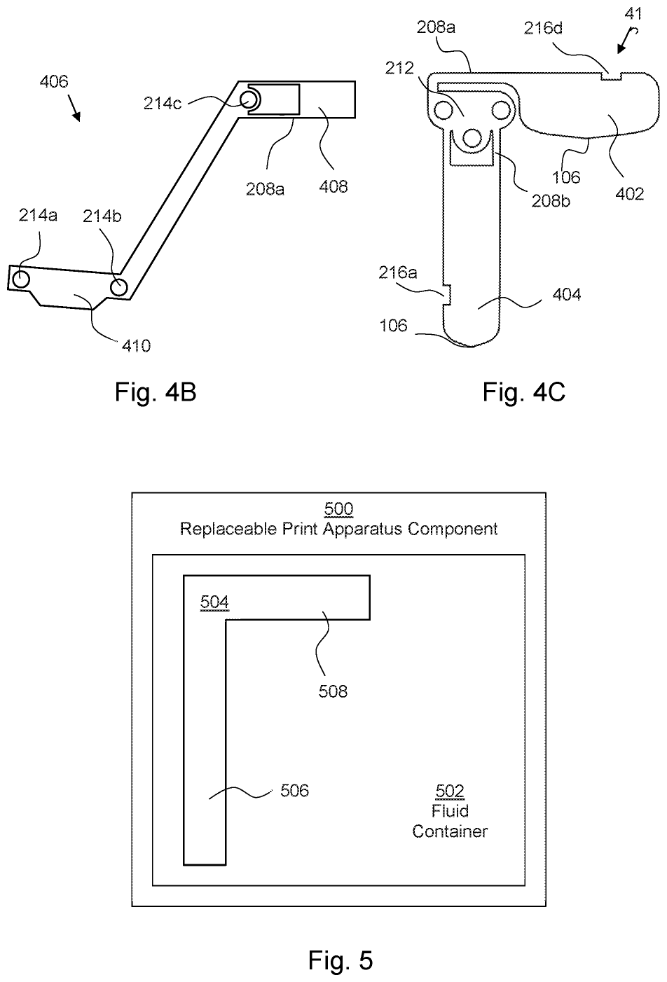

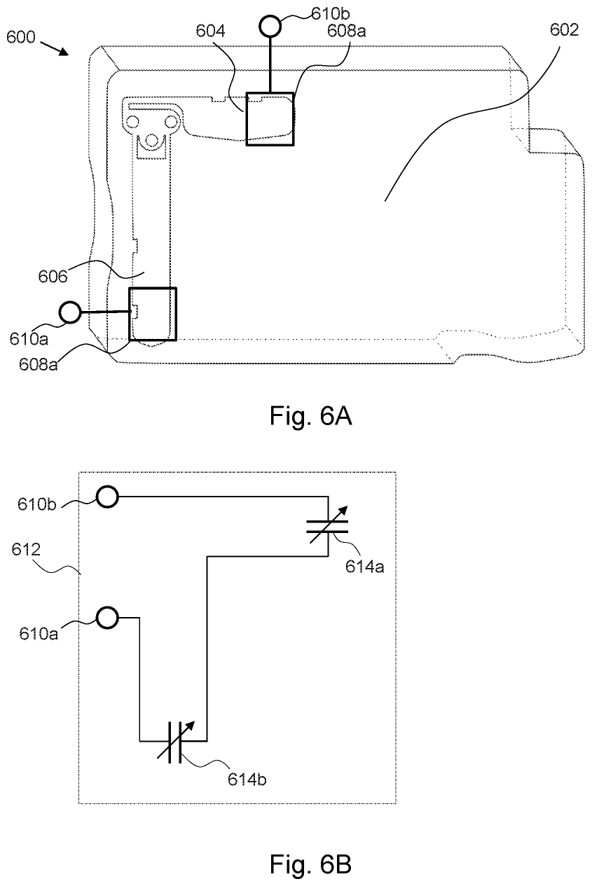

FIG. 6A is an example of a print agent container 600 comprising a fluid reservoir 602 and first 604 and second 606 resonator elements disposed within the fluid reservoir 602 at different fluid depths and which extend in different directions. The first resonator element 604 exhibits resonant behaviour (i.e. vibration at the resonant or natural frequency of the resonator element) when fluid is at a first depth in the reservoir 602 and second resonator element 606 exhibits resonant behaviour when fluid is at a second depth in the reservoir 602, and the first and second resonator elements 604, 606 have a common mounting point.

The print agent container 600 comprises capacitive plates 608a, b provided on the outer housing thereof, each of which is associated with a connection terminal 610a, 610b.

FIG. 6B shows an equivalent circuit 612, in which distal regions of the first and second resonator elements 604, 606 provide plates of two variable capacitors 614a, 614b (which may be electrically connected via the material of the sensor, or an electrical connection such as a wire provided thereon), with opposing plates being provided by the capacitive plates 608a, b provided on the outer housing of the container 600. Sensor circuitry connected to the connection terminals 610a, 610b may query the sensor, for example following a stimulus, and may determine by measuring indications of the capacitance, whether a sensor is present, absent, and whether a vibrational paddle/distal portion thereof is uncovered or submerged.

While the method, apparatus and related aspects have been described with reference to certain examples, various modifications, changes, omissions, and substitutions can be made without departing from the spirit of the present disclosure. It is intended, therefore, that the method, apparatus and related aspects be limited only by the scope of the following claims and their equivalents. It should be noted that the above-mentioned examples illustrate rather than limit what is described herein, and that those skilled in the art will be able to design many alternative implementations without departing from the scope of the appended claims. Features described in relation to one example may be combined with features of another example.

The word “comprising” does not exclude the presence of elements other than those listed in a claim, and “a” or “an” does not exclude a plurality.

The features of any dependent claim may be combined with the features of any of the independent claims or other dependent claims.

1. A fluid level sensor comprising a vibrational paddle wherein an edge of the vibrational paddle comprises a fluid surface contact point having a peaked profile.

2. A fluid level sensor according to claim 1 further comprising a distal portion and a proximal portion, wherein the proximal portion has a first solid surface area per unit length and the distal portion has a second solid surface area per unit length, wherein the second solid surface area is greater than the first solid surface area.

3. A fluid level sensor according to claim 2 wherein the proximal portion has a first width and the distal portion has a second width, the second width being greater than the first width.

4. A fluid sensor according to claim 2 wherein the proximal portion comprises a cut-out section.

5. A fluid sensor according to claim 1 which comprises a stamped spring plate.

6. A fluid sensor according to claim 1 in which the sensor is substantially planar.

7. A fluid sensor according to claim 1 in which the vibrational paddle comprises rounded corners.

8. A fluid sensor according to claim 1 comprising a plurality of vibrational paddles.

9. A fluid sensor according to claim 8 wherein the plurality of vibrational paddles are mounted at relatively offset angles.

10. A fluid sensor according to claim 1 comprising a plurality of attachment points for mounting a removable mass.

11. A replaceable print apparatus component comprising:
a fluid container; and
a fluid level sensor disposed within the fluid container comprising first and second vibrational limbs, wherein the first and second limbs extend in different directions, are disposed at different fluid depths within the container and are associated with respective first and second resonant behaviors.

12. A replaceable print apparatus component according to claim 11 wherein at least one of the first and the second arm comprises a distal paddle portion.

13. A replaceable print apparatus component according to claim 11 wherein the first and second arm extend from a common origin.

14. A replaceable print apparatus component according to claim 11 in which the first arm comprises a longitudinally extending arm and the second arm comprises a laterally extending arm, wherein the second arm extends across a width of the first arm.

15. A print agent container comprising:
a fluid reservoir; and
first and second resonator elements disposed within the fluid reservoir at different fluid depths and which extend in different directions, wherein the first resonator element exhibits resonant behavior when fluid is at a first depth in the reservoir and second resonator element exhibits resonant behavior when fluid is at a second depth in the reservoir, and the first and second resonator elements have a common mounting point.
